(19) United States
(12) Patent Application Publication
(10) Pub. No.: US 2017/0024610 A1
(43) Pub. Date: Jan. 26, 2017

(54) MOTION ANALYSIS APPARATUS, MOTION ANALYSIS SYSTEM, MOTION ANALYSIS METHOD, AND DISPLAY METHOD AND PROGRAM OF MOTION ANALYSIS INFORMATION

(71) Applicant: SEIKO EPSON CORPORATION, Tokyo (JP)

(72) Inventors: Yuya ISHIKAWA, Chino-shi (JP); Kazuhiro SHIBUYA, Shiojiri-shi (JP)

(73) Assignee: SEIKO EPSON CORPORATION, Tokyo (JP)

(21) Appl. No.: 15/116,274

(22) PCT Filed: Mar. 10, 2015
(86) PCT No.: PCT/JP2015/001310

§ 371 Date: Aug. 3, 2016

(30) Foreign Application Priority Data
Mar. 20, 2014 (JP) 2014-058839

(51) Int. Cl. G06K 9/00; A63B 71/06; A63B 24/00

(52) U.S. Cl. CPC G06K 9/00342; A63B 24/0062; A63B 24/0021; A63B 71/06; A63B 2024/0028

(57) ABSTRACT

A motion analysis apparatus includes an action detection portion that detects a first action performed in correlation with a hit ball direction after a subject hits a ball using measured data which is measured by a sensor unit attached to at least one of golf club and the subject, a hit ball information generation portion that specifies a hit ball direction according to the first action so as to generate hit ball information including the hit ball direction, a motion analysis portion that analyzes motion in which the subject has hit the ball, so as to generate motion analysis information, and a storage processing portion that stores the motion analysis information and the hit ball information in correlation with each other.

### TECHNICAL FIELD

The present invention relates to a motion analysis apparatus, a motion analysis system, a motion analysis method, and a display method and a program of motion analysis information.

### BACKGROUND ART

In sports such as golf, tennis, and baseball, it is considered that athletic ability can be improved by improving rhythm or form of a swinging motion, and, thus, in recent years, a motion analysis apparatus has been put into practical use, in which motion of a subject is analyzed and is presented using output data from a sensor attached to an exercise appliance. For example, PTL 1 discloses an apparatus in which an acceleration sensor and a gyro sensor are attached to a golf club, and the golf swing of a subject is analyzed.

### CITATION LIST

### Patent Literature

PTL 1: JP-A-2008-73210

### SUMMARY OF INVENTION

### Technical Problem

However, as in the apparatus disclosed in PTL 1, in a motion analysis apparatus of the related art, motion analysis regarding, for example, a swing speed or a swing trajectory can be performed using output data from the sensor, but it is hard to analyze an actual hit ball direction on the basis of the output data from the sensor. Therefore, a result of the motion analysis cannot be associated with a hit ball direction, and, thus, in a case where a subject desires association therebetween, it is necessary to perform troublesome manual work such as checking a hit ball direction with the naked eye and writing the direction on paper.

The invention has been made in consideration of the above-described problems, and some aspects of the invention are to provide a motion analysis apparatus, a motion analysis system, a motion analysis method, and a display method and a program of motion analysis information, capable of associating a result of motion analysis with a hit ball direction.

### Solution to Problem

The invention has been made in order to solve at least some of the above-described problems, and can be realized in the following aspects or application examples.

### APPLICATION EXAMPLE 1

A motion analysis apparatus according to this application example includes an action detection portion that detects a first action performed in correlation with a hit ball direction after a subject hits a ball using measured data which is measured by a sensor unit attached to at least one of an exercise appliance and the subject operating the exercise appliance; a hit ball information generation portion that specifies a hit ball direction according to the first action and generates hit ball information including the hit ball direction; a motion analysis portion that analyzes motion in which the subject has hit the ball using the exercise appliance, and generates motion analysis information; and a storage processing portion that stores the motion analysis information and the hit ball information in a storage section in correlation with each other.

The exercise appliance is an appliance used to hit a ball, such as a golf club, a tennis racket, a baseball bat, and a hockey stick.

The sensor unit may include some or all of an acceleration sensor, an angular velocity sensor, a geomagnetic sensor, and a pressure sensor, and may be, for example, an inertial measurement unit (IMU) which can measure acceleration or angular velocity. The sensor unit may be attachable to and detachable from an exercise appliance or a subject, and may be fixed to an exercise appliance so as not to be detached therefrom, for example, as a result of being built into the exercise appliance.

According to the motion analysis apparatus of this application example, it is possible to detect the first action performed by the subject so as to specify a hit ball direction using measured data from the sensor unit, and thus to store a motion analysis result and the hit ball direction in association with each other. Therefore, the subject can recognize a relationship between the motion analysis result and the hit ball direction without imposing an excessive burden thereon.

### APPLICATION EXAMPLE 2

The motion analysis apparatus according to the application example may further include a display processing portion that displays the motion analysis information and the hit ball information on a display section in correlation with each other.

According to the motion analysis apparatus of this application example, the subject views the information displayed on the display section and can thus visually recognize a relationship between the motion analysis result and the hit ball direction.

### APPLICATION EXAMPLE 3

In the motion analysis apparatus according to the application example, the first action may be an action of indicating a hit ball direction.

According to the motion analysis apparatus of this application example, the subject may perform a simple action such as indicating a hit ball direction after hitting a ball in order to specify the hit ball direction.

### APPLICATION EXAMPLE 4

In the motion analysis apparatus according to the application example, the first action may be an action of twisting the exercise appliance or the arm of the subject.

According to the motion analysis apparatus of this application example, the subject may perform a simple action such as twisting the exercise appliance or the arm after hitting a ball in order to specify the hit ball direction.

### APPLICATION EXAMPLE 5

In the motion analysis apparatus according to the application example, the action detection portion may detect a second action performed after the subject hits the ball using the exercise appliance and before the subject performs the first action, using the measured data, and, in a case where the second action is detected, the hit ball information generation portion may specify a hit ball direction according to the first action and generate hit ball information including the hit ball direction.

According to the motion analysis apparatus of this application example, it is possible to clearly differentiate a ball hitting action of the subject from the first action by detecting the second action performed after the subject hits the ball and before the subject performs the first action, and thus to reduce a probability of wrongly specifying a hit ball direction.

### APPLICATION EXAMPLE 6

In the motion analysis apparatus according to the application example, the second action may be an action of applying impact to the exercise appliance.

According to the motion analysis apparatus of this application example, the subject may perform a simple action such as applying impact to the exercise appliance in order to differentiate a ball hitting action from the first action.

### APPLICATION EXAMPLE 7

In the motion analysis apparatus according to the application example, the second action may be an action of stopping the exercise appliance.

According to the motion analysis apparatus of this application example, the subject may perform a simple action such as stopping the exercise appliance in order to differentiate a ball hitting action from the first action.

### APPLICATION EXAMPLE 8

In the motion analysis apparatus according to the application example, the action detection portion may detect a third action performed in correlation with the way of a hit ball curving after the subject hits the ball, using the measured data, and the hit ball information generation portion may specify the way of the hit ball curving according to the third action, and generate the hit ball information including the hit ball direction and the way of the hit ball curving.

According to the motion analysis apparatus of this application example, it is possible to specify a hit ball direction and the way of the hit ball curving by detecting the third action performed by the subject using measured data from the sensor unit, and thus to store a motion analysis result, and the hit ball direction and the way of the hit ball curving in association with each other. Therefore, the subject can recognize a relationship between the motion analysis result and the hit ball direction and the way of the hit ball curving without imposing an excessive burden thereon.

### APPLICATION EXAMPLE 9

In the motion analysis apparatus according to the application example, the motion analysis portion may generate the motion analysis information using the measured data.

According to the motion analysis apparatus of this application example, since motion of the subject is analyzed using the measured data, for example, a large-size apparatus such as a camera is not necessary, and it is possible to reduce a limitation on a measurement location.

### APPLICATION EXAMPLE 10

A motion analysis system according to this application example includes any one of the motion analysis apparatuses described above; and the sensor unit.

Since the motion analysis system of the application example includes the motion analysis apparatus which can store a motion analysis result and a hit ball direction in association with each other, the subject can recognize a relationship between the motion analysis result and the hit ball direction without imposing an excessive burden thereon.

### APPLICATION EXAMPLE 11

A motion analysis method according to this application example includes detecting a first action performed in correlation with a hit ball direction after a subject hits a ball using measured data which is measured by a sensor unit attached to at least one of an exercise appliance and the subject operating the exercise appliance; generating hit ball information including a hit ball direction by specifying the hit ball direction according to the first action; generating motion analysis information by analyzing motion in which the subject has hit the ball using the exercise appliance; and storing the motion analysis information and the hit ball information in a storage section in correlation with each other.

According to the motion analysis method of this application example, it is possible to detect the first action performed by the subject so as to specify a hit ball direction using measured data from the sensor unit, and thus to store a motion analysis result and the hit ball direction in association with each other. Therefore, the subject can recognize a relationship between the motion analysis result and the hit ball direction without imposing an excessive burden thereon.

### APPLICATION EXAMPLE 12

The motion analysis method according to the application example may further include calculating an attitude of the sensor unit using measured data which is measured by the sensor unit, and, in the generating of the hit ball information, the hit ball direction may be specified on the basis of an attitude of the sensor unit when the subject performs the first action.

### APPLICATION EXAMPLE 13

The motion analysis method according to the application example may further include detecting a timing at which the subject has hit the ball using data measured by the sensor unit after the subject starts motion; detecting a second action performed before the subject performs the first action, using data measured by the sensor unit after the timing; and generating hit ball information including a hit ball direction by specifying the hit ball direction according to the first action after detecting the second action.

According to the motion analysis method of these application examples, it is possible to clearly differentiate a ball hitting action of the subject from the first action by detecting the second action performed after the subject hits the ball and before the subject performs the first action, and thus to reduce a probability of wrongly specifying a hit ball direction.

### APPLICATION EXAMPLE 14

A display method of motion analysis information according to this application example includes detecting a first action performed in correlation with a hit ball direction after a subject hits a ball using measured data which is measured by a sensor unit attached to at least one of an exercise appliance and the subject operating the exercise appliance; generating hit ball information including a hit ball direction by specifying the hit ball direction according to the first action; generating motion analysis information by analyzing motion in which the subject has hit the ball using the exercise appliance; and displaying the motion analysis information and the hit ball information on a display section in correlation with each other.

According to the display method of motion analysis information of this application example, it is possible to detect the first action performed by the subject so as to specify a hit ball direction using measured data from the sensor unit, and thus to display a motion analysis result and the hit ball direction in association with each other. Therefore, the subject can visually recognize a relationship between the motion analysis result and the hit ball direction without imposing an excessive burden thereon.

### APPLICATION EXAMPLE 15

A program according to this application example causes a computer to execute detecting a first action performed in correlation with a hit ball direction after a subject hits a ball using measured data which is measured by a sensor unit attached to at least one of an exercise appliance and the subject operating the exercise appliance; generating hit ball information including a hit ball direction by specifying the hit ball direction according to the first action; generating motion analysis information by analyzing motion in which the subject has hit the ball using the exercise appliance; and displaying the motion analysis information and the hit ball information on a display section in correlation with each other.

According to the program of this application example, it is possible to detect the first action performed by the subject so as to specify a hit ball direction using measured data from the sensor unit, and thus to store a motion analysis result and the hit ball direction in association with each other. Therefore, the subject can recognize a relationship between the motion analysis result and the hit ball direction without imposing an excessive burden thereon.

### BRIEF DESCRIPTION OF DRAWINGS

FIG. 1 is a diagram illustrating a motion analysis system according to the present embodiment.

FIG. 2(A) to 2(C) are diagrams illustrating examples of a position where a sensor unit is attached.

FIG. 3 is a diagram illustrating procedures of actions performed by a subject in a first embodiment.

FIGS. 4(A) and 4(B) are diagrams for explaining examples of actions performed by the subject in correlation with a hit ball direction.

FIG. 5 is a diagram illustrating a configuration example of a motion analysis system according to the present embodiment.

FIG. 6 is a diagram for explaining a hit ball direction.

FIG. 7 is a flowchart illustrating examples of procedures of a motion analysis process in the first embodiment.

FIG. 8 is a flowchart illustrating examples of procedures of a process of detecting a timing at which the subject has hit a ball.

FIG. 9 is a diagram illustrating an example of a position at which and a direction in which the sensor unit is attached.

FIG. 10(A) is a diagram in which three-axis angular velocities during swing are displayed in a graph, FIG. 10(B) is a diagram in which a calculated value of a norm of the three-axis angular velocities is displayed in a graph, and FIG. 10(C) is a diagram in which a calculated value of a derivative of the norm of the three-axis angular velocities is displayed in a graph.

FIG. 11 is a flowchart illustrating examples of procedures of a process of calculating an attitude of the sensor unit.

FIG. 12 is a diagram for explaining an incidence angle and a face angle during hitting of a ball.

FIG. 13 is a diagram illustrating an example of a display screen in which motion analysis information and hit ball information are correlated with each other.

FIG. 14 is a diagram illustrating another example of a display screen in which motion analysis information and hit ball information are correlated with each other.

FIG. 15 is a diagram illustrating procedures of actions performed by a subject in a second embodiment.

FIG. 16 is a diagram for explaining an example of an action performed by the subject in correlation between a hit ball direction and the way of the hit ball curving.

FIG. 17 is a flowchart illustrating examples of procedures of a motion analysis process in the second embodiment.

### DESCRIPTION OF EMBODIMENTS

Hereinafter, preferred embodiments of the invention will be described with reference to the drawings. The embodiments described below are not intended to improperly limit the content of the invention disclosed in the claims. In addition, all constituent elements described below are not essential constituent elements of the invention.

Hereinafter, a motion analysis system (motion analysis apparatus) analyzing a golf swing will be described as an example.

### 1. MOTION ANALYSIS SYSTEM

### 1-1. First Embodiment

### [Outline of Motion Analysis System]

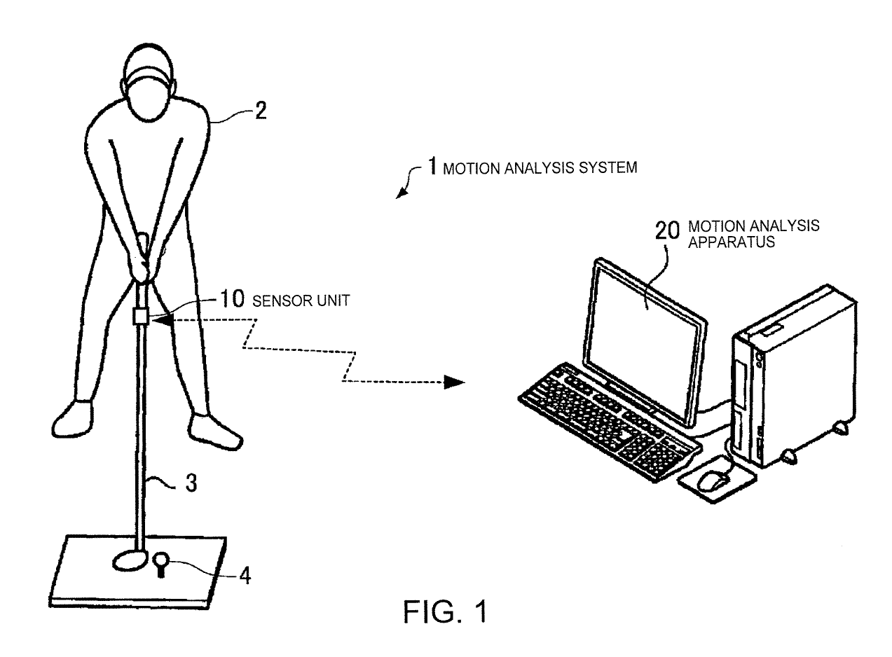

FIG. 1 is a diagram for explaining an outline of a motion analysis system according to the present embodiment. A motion analysis system 1 of the present embodiment is configured to include a sensor unit 10 and a motion analysis apparatus 20.

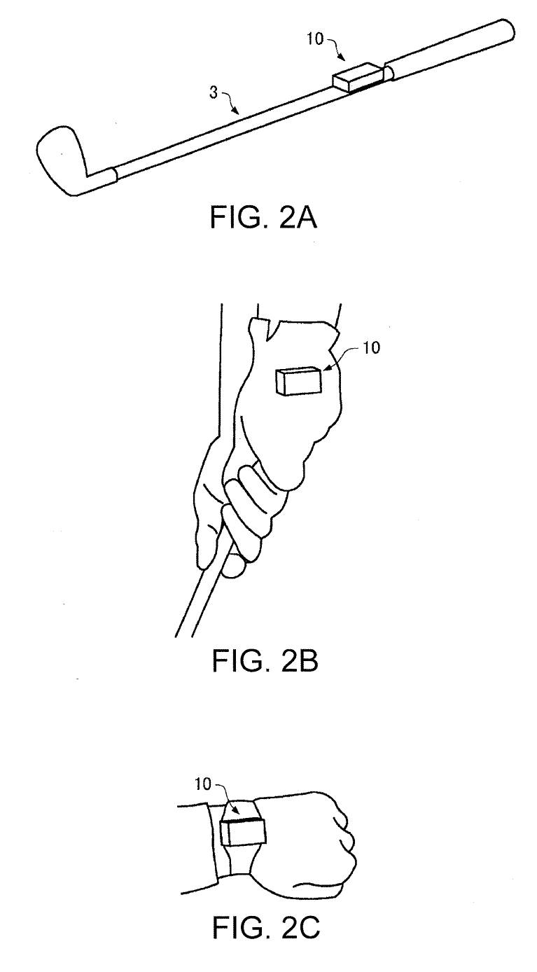

The sensor unit 10 can measure acceleration generated in each axial direction of three axes and angular velocity generated around each of the three axes, and is attached to at least one of a golf club 3 (an example of an exercise appliance) and a subject 2. For example, as illustrated in FIG. 2(A), the sensor unit 10 may be attached to a part of a shaft of the golf club 3, for example, at a position close to a grip portion. The shaft is a shaft portion other than the head of the golf club 3 and also includes the grip portion. The sensor unit 10 may be attached to the hand or a glove of the subject as illustrated in FIG. 2(B). The sensor unit 10 may be attached to an accessory such as a wrist watch as illustrated in FIG. 2(C).

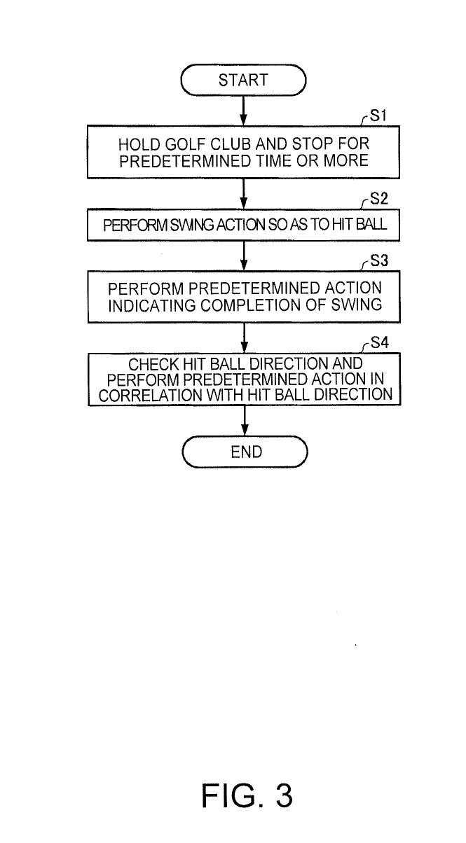

The subject 2 performs a swing action for hitting a golf ball 4 according to predefined procedures. FIG. 3 is a diagram illustrating procedures of actions performed by the subject 2. As illustrated in FIG. 3, first, the subject 2 holds the golf club 3, and stops for a predetermined time period or more (for example, for one second or more) (step S1). Next, the subject 2 performs a swing action so as to hit the golf ball (step S2). Next, the subject 2 performs a predetermined action (an example of a second action) indicating completion of the swing (step S3). This predetermined action may be, for example, an action of applying a large impact to the golf club 3 by tapping the ground with the golf club 3, and may be a stoppage action for a predetermined time period or more (for example, for one second or more). Finally, the subject 2 checks a hit ball direction, and performs a predetermined action (an example of a first action) in correlation with the hit ball direction (step S4).

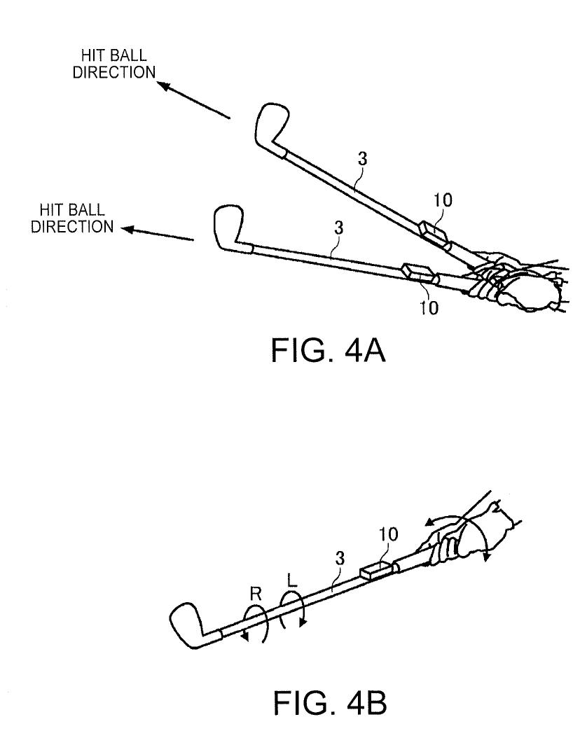

FIGS. 4(A) and 4(B) are diagrams for explaining an example of the action performed by the subject 2 in correlation with the hit ball direction in step S4 in FIG. 3. For example, as illustrated in FIG. 4(A), the subject 2 performs an action of indicating a hit ball direction with the golf club 3 (directing the head of the golf club 3 in the hit ball direction). For example, as illustrated in FIG. 4(B), the subject 2 may perform an action of twisting the golf club 3 or the arm in correlation with the hit ball direction. For example, if the hit ball direction is the right direction, the subject 2 performs an action of twisting the arm holding the golf club 3 to the right, and if the hit ball direction is the left direction, the subject performs an action of twisting the arm to the left. Therefore, the sensor unit 10 is rotated to the right (R) (rotated clockwise) or to the left (L) (rotated counterclockwise) around a long axis (shaft axis) of the golf club 3. In a case where the action illustrated in FIG. 4(B) is performed, the subject 2 may set a right front direction (target direction) in advance, may not perform an action of twisting the arm in a case where a hit ball direction nearly matches the target direction, and may perform an action of twisting the golf club 3 or the arm so that a rotation amount or a rotation speed of the sensor unit 10 is increased as deviation becomes larger in a case where a hit ball direction is deviated to the right direction or the left direction relative to the target direction.

While the subject 2 performs the action of hitting the golf ball 4 according to the procedures illustrated in FIG. 3, the sensor unit 10 measures three-axis acceleration and three-axis angular velocity at a predetermined cycle (for example, 1 ms), and sequentially transmits measured data to the motion analysis apparatus 20. The sensor unit 10 may instantly transmit the measured data, and may store the measured data in an internal memory and transmit the measured data at a desired timing such as completion of a swing action of the subject 2. Alternatively, the sensor unit 10 may store the measured data in an attachable/detachable recording medium such as a memory card, and the motion analysis apparatus 20 may read the measured data from the recording medium.

The motion analysis apparatus 20 analyzes the motion performed by the subject 2 using the data measured by the sensor unit 10 so as to generate motion analysis information (swing information) and hit ball information (including the hit ball direction), and stores the information in a storage section in correlation with each other. The motion analysis apparatus 20 displays the motion analysis information and the hit ball information on a display section in correlation with each other through a predetermined input operation or automatically.

Communication between the sensor unit 10 and the motion analysis apparatus 20 may be wireless communication, and may be wired communication.

### [Configuration of Motion Analysis System]

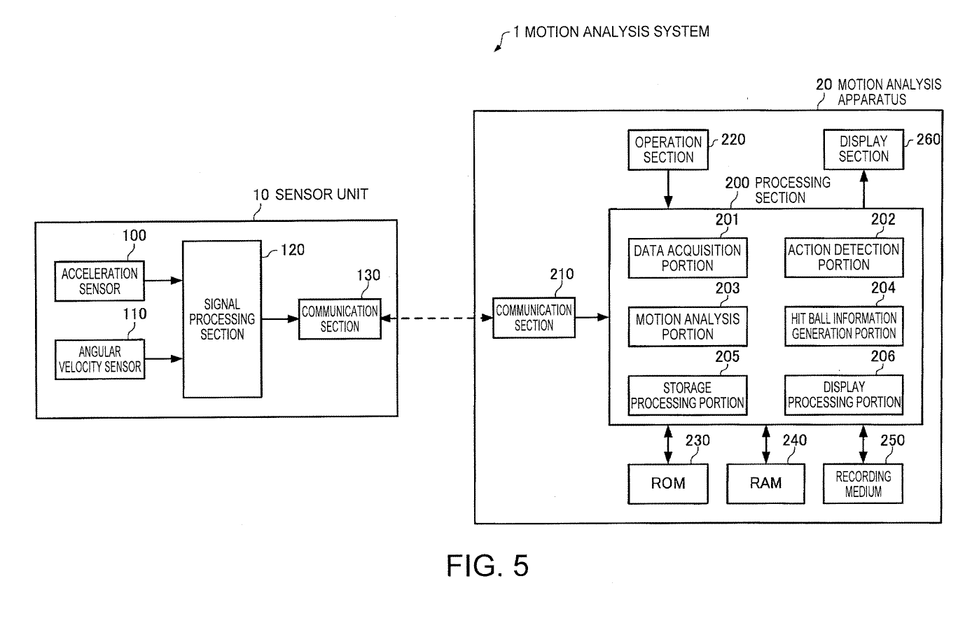

FIG. 5 is a diagram illustrating configuration examples of the sensor unit 10 and the motion analysis apparatus 20. As illustrated in FIG. 5, in the present embodiment, the sensor unit 10 is configured to include an acceleration sensor 100, an angular velocity sensor 110, a signal processing section 120, and a communication section 130.

The acceleration sensor 100 measures respective accelerations in three axial directions which intersect (ideally, orthogonal to) each other, and outputs digital signals (acceleration data) corresponding to magnitudes and directions of the measured three-axis accelerations.

The angular velocity sensor 110 measures respective angular velocities in three axial directions which intersect (ideally, orthogonal to) each other, and outputs digital signals (angular velocity data) corresponding to magnitudes and directions of the measured three-axis angular velocities.

The signal processing section 120 receives the acceleration data and the angular velocity data from the acceleration sensor 100 and the angular velocity sensor 110, respectively, adds time information thereto, stores the data in a storage portion (not illustrated), adds time information to the stored measured data (the acceleration data and the angular velocity data) so as to generate packet data conforming to a communication format, and outputs the packet data to the communication section 130.

Ideally, the acceleration sensor 100 and the angular velocity sensor 110 are provided in the sensor unit 10 so that the three axes thereof match three axes (an x axis, a y axis, and a z axis) of an orthogonal coordinate system (sensor coordinate system) defined for the sensor unit 10, but, actually, errors occur in installation angles. Therefore, the signal processing section 120 performs a process of converting the acceleration data and the angular velocity data into data in the xyz coordinate system (sensor coordinate system) using a correction parameter which is calculated in advance according to the installation angle errors.

The signal processing section 120 performs a process of correcting the temperatures of the acceleration sensor 100 and the angular velocity sensor 110. The acceleration sensor 100 and the angular velocity sensor 110 may have a temperature correction function.

The acceleration sensor 100 and the angular velocity sensor 110 may output analog signals, and, in this case, the signal processing section 120 may A/C-convert an output signal from the acceleration sensor 100 and an output signal from the angular velocity sensor 110 so as to generate measured data (acceleration data and angular velocity data), and may generate communication packet data using the data.

The communication section 130 performs a process of transmitting packet data received from the signal processing section 120 to the motion analysis apparatus 20, or a process of receiving a control command from the motion analysis apparatus 20 and sending the control command to the signal processing section 120. The signal processing section 120 performs various processes corresponding to control commands.

The motion analysis apparatus 20 is configured to include a processing section 200, a communication section 210, an operation section 220, a ROM 230, a RAM 240, a recording medium 250, and a display section 260, and may be, for example, a personal computer (PC) or a portable apparatus such as a smart phone.

The communication section 210 performs a process of receiving packet data transmitted from the sensor unit 10 and sending the packet data to the processing section 200, or a process of transmitting a control command from the processing section 200 to the sensor unit 10.

The operation section 220 performs a process of acquiring operation data from a user and sending the operation data to the processing section 200. The operation section 220 may be, for example, a touch panel type display, a button, a key, or a microphone.

The ROM 230 stores a program for the processing section 200 performing various calculation processes or a control process, or various programs or data for realizing application functions.

The RAM 240 is used as a work area of the processing section 200, and is a storage section which temporarily stores a program or data read from the ROM 230, data which is input from the operation section 220, results of calculation executed by the processing section 200 according to various programs, and the like.

The recording medium 250 is a nonvolatile storage section storing data which is required to be preserved for a long period of time among data items generated through processing of the processing section 200. The recording medium 250 may store a program for the processing section 200 performing various calculation processes and a control process, or various programs or data for realizing application functions.

The display section 260 displays a processing result in the processing section 200 as text, a graph, a table, animation, and other images. The display section 260 may be, for example, a CRT, an LCD, a touch panel type display, and a head mounted display (HMD). A single touch panel type display may realize functions of the operation section 220 and the display section 260.

The processing section 200 performs a process of transmitting a control command to the sensor unit 10 according to a program stored in the ROM 230 or the recording medium 250, or a program which is received from a server via a network and is stored in the RAM 240 or the recording medium 250, various calculation processes on data which is received from the sensor unit 10 via the communication section 210, and various control processes. Particularly, in the present embodiment, by executing the program, the processing section 200 functions as a data acquisition portion 201, an action detection portion 202, a motion analysis portion 203, a hit ball information generation portion 204, a storage processing portion 205, and a display processing portion 206.

The data acquisition portion 201 performs a process of receiving packet data which is received from the sensor unit 10 by the communication section 210, acquiring time information and measured data (acceleration data and angular velocity data) in the sensor unit 10 from the received packet data, and sending the time information and the measured data to the storage processing portion 205.

The storage processing portion 205 performs a process of receiving the time information and the measured data from the data acquisition portion 201 and storing the time information and the measured data in the RAM 240 in correlation with each other.

The action detection portion 202 performs a process of detecting an action in motion in which the subject 2 has hit a ball using the golf club 3 on the basis of the time information and the measured data stored in the RAM 240. Specifically, the action detection portion 202 detects the stoppage action (the action in step S1 in FIG. 3) performed by the subject 2 before starting a swing action, the predetermined action (the action in step S3 in FIG. 3) indicating completion of the swing, and the predetermined action (the action in step S4 in FIG. 3) performed in correlation with the hit ball direction, in correlation with the time. The action detection portion 202 detects a timing (time point) at which the subject 2 has hit the ball in the period of the swing action (the action in step S2 in FIG. 3).

The motion analysis portion 203 performs a process of calculating an offset amount using the measured data during stoppage, detected by the action detection portion 202, subtracting the offset amount from the measured data so as to perform bias correction, and calculating a position and an attitude of the sensor unit 10 using the bias-corrected measured data. For example, the motion analysis portion 203 defines an XYZ coordinate system (world coordinate system) which has a target line indicating a hit ball direction as an X axis, an axis on a horizontal plane which is perpendicular to the X axis as Y axis, and a vertically upward direction (a direction opposite to the gravitational direction) as a Z axis, and calculates a position and an attitude of the sensor unit 10 in the XYZ coordinate system (world coordinate system). The target line indicates, for example, a direction in which a ball flies straight. A position and an attitude of the sensor unit 10 during address (during stoppage action) of the subject 2 may be respectively set as an initial position and an initial attitude. The motion analysis portion 203 may set an initial position of the sensor unit 10 to the origin (0,0,0) of the XYZ coordinate system, and may calculate an initial attitude of the sensor unit 10 on the basis of acceleration data and a direction of the gravitational acceleration during address (during stoppage action) of the subject 2. An attitude of the sensor unit 10 maybe expressed by, for example, rotation angles (a roll angle, a pitch angle, and a yaw angle) around the X axis, the Y axis, and the Z axis, Euler angles, or a quaternion.

The motion analysis portion 203 defines a motion analysis model (double pendulum model) in which features (a shaft length, a position of the centroid, and the like) of the golf club 3 or human features (an arm length, a position of the centroid, a joint bending direction, and the like) are taken into consideration, and calculates a trajectory of the motion analysis model using information regarding the position and the attitude of the sensor unit 10. The motion analysis portion 203 analyzes motion in which the subject 2 has hit a ball using the golf club 3 on the basis of the trajectory information of the motion analysis model and the detection information from the action detection portion 202, so as to generate motion analysis information (swing information). The motion analysis information is, for example, information regarding a trajectory of the swing (a trajectory of the head of the golf club 3), rhythm of the swing from a backswing to follow-through, a head speed, an incidence angle (club path) or a face angle during hitting of a ball, shaft rotation (a change amount of a face angle during swing), a V zone, and a deceleration rate of the golf club 3, or information regarding a variation in these information pieces in a case where the subject 2 performs a plurality of swings.

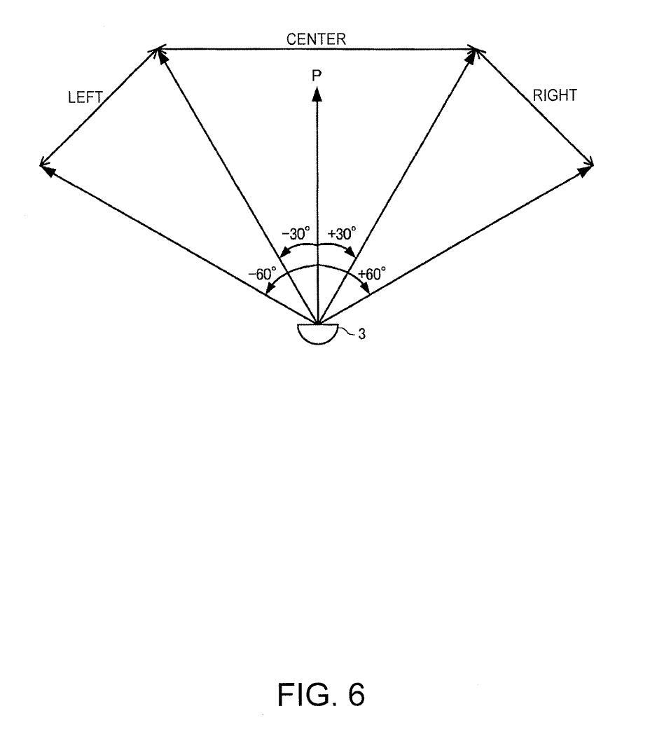

The hit ball information generation portion 204 specifies a hit ball direction according to the predetermined action (the action in step S4 in FIG. 3) performed by the subject 2 in correlation with the hit ball direction, detected by the action detection portion 202, and generates hit ball information including the hit ball direction. For example, as illustrated in FIG. 6, the hit ball information generation portion 204 may specify a hit ball direction so that the hit ball direction is “center” if an angle (an angle projected onto a horizontal plane) of the hit ball calculated on the basis of the action of the subject 2 (the action in step S4 in FIG. 3) is within ±30°, the hit ball direction is “right” if the angle is larger than +30° and equal to or smaller than +60°, and the hit ball direction is “left” if the angle is smaller than −30° and equal to or larger than −60°, with respect to an axis P in which an axis orthogonal to a face surface of the golf club 3 during stoppage of the subject 2 (during the action in step S1 in FIG. 3) is projected onto the horizontal plane. In a case where the subject 2 does not want to store information regarding a hit ball direction such as a case where the subject has missed a ball, or causes the ball not to fly almost straight, the subject may not perform the predetermined action correlated with a hit ball direction.

The signal processing section 120 of the sensor unit 10 may calculate an offset amount of measured data so as to perform bias correction on the measured data, and the acceleration sensor 100 and the angular velocity sensor 110 may have a bias correction function. In this case, it is not necessary for the motion analysis portion 203 to perform bias correction on the measured data.

The storage processing portion 205 stores the motion analysis information generated by the motion analysis portion 203 and the hit ball information generated by the hit ball information generation portion 204 in the RAM 240 in correlation with each other, and also performs a process of storing the information in the recording medium 250 in a case where the information is desired to be kept as a record.

The display processing portion 206 performs a process of reading the motion analysis information and the hit ball information stored in the RAM 240 or the recording medium 250 automatically or when a predetermined input operation is performed after the swing action of the subject 2 is completed, and displaying the read motion analysis information and hit ball information on the display section 260 in correlation with each other.

### [Motion Analysis Process]

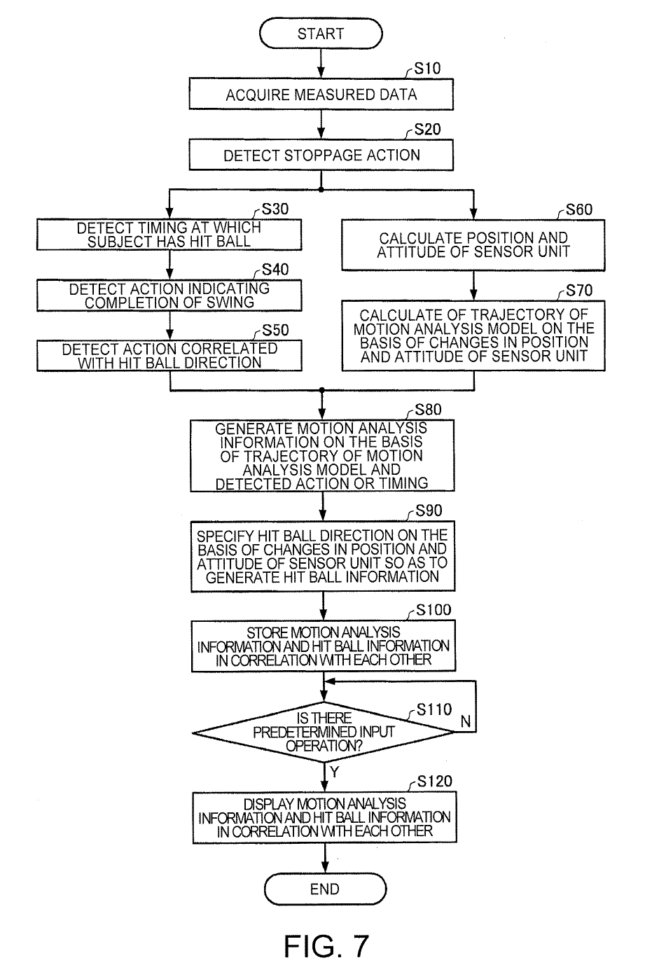

FIG. 7 is a flowchart illustrating examples of procedures of a motion analysis process performed by the processing section 200 in the first embodiment.

As illustrated in FIG. 7, first, the processing section 200 acquires measured data from the sensor unit 10 (step S10). If initial measured data in a swing action (also including a stoppage action) of the subject 2 is acquired in step S10, the processing section 200 may perform processes in step S20 and the subsequent steps in real time, and may perform the processes in step S20 and the subsequent steps after acquiring some or all of a series of measured data in the swing action of the subject 2 from the sensor unit 10.

Next, the processing section 200 detects a stoppage action of the subject 2 (the action in step S1 in FIG. 3) using the acquired measured data (step S20). In a case where the process is performed in real time, when the stoppage action is detected, the processing section 200 may output, for example, a predetermined image or sound, or may turn on an LED provided in the sensor unit 10, so as to notify the subject 2 of detection of the stoppage state, and the subject 2 may start a swing after checking the notification.

Next, the processing section 200 sequentially performs a process (step S30) of detecting a timing at which the subject 2 has hit a ball, a process (step S40) of detecting an action (the action in step S3 in FIG. 3) indicating completion of the swing, performed by the subject 2, and a process (step S50) of detecting an action (the action in step S4 in FIG. 3) correlated with a hit ball direction, performed by the subject 2.

The processing section 200 performs a process (step S60) of calculating a position and an attitude of the sensor unit 10, and a process (step S70) of calculating a trajectory of a motion analysis model on the basis of changes in the position and the attitude of the sensor unit 10, in parallel to the processes in steps S30 to S50. In step S60, the processing section 200 sets an initial position of the sensor unit 10 to the origin of the XYZ coordinate system, calculates an initial attitude in the XYZ coordinate system of the sensor unit 10 using the measured data during the stoppage action, detected in step S20, and then calculates the position and the attitude of the sensor unit 10 in correlation with the time using subsequent measured data.

Next, the processing section 200 generates motion analysis information regarding the swing action performed by the subject 2 on the basis of the trajectory of the motion analysis model calculated in step S70 and the actions or the timing detected in steps S20 to S50 (step S80).

Next, the processing section 200 specifies a hit ball direction on the basis of changes in the position and the attitude of the sensor unit 10 calculated in step S60, corresponding to the action detected in step S50, and thus generates hit ball information (step S90).

Next, the processing section 200 stores the motion analysis information and the hit ball information generated in step S80 in correlation with each other (step S100).

Finally, the processing section 200 displays the motion analysis information and the hit ball information stored in step S100, in correlation with each other, in a case where there is a predetermined input operation (Y in step S110) (step S120).

In the flowchart of FIG. 7, order of the respective steps may be changed as appropriate within an allowable range.

### [Impact Detection Process]

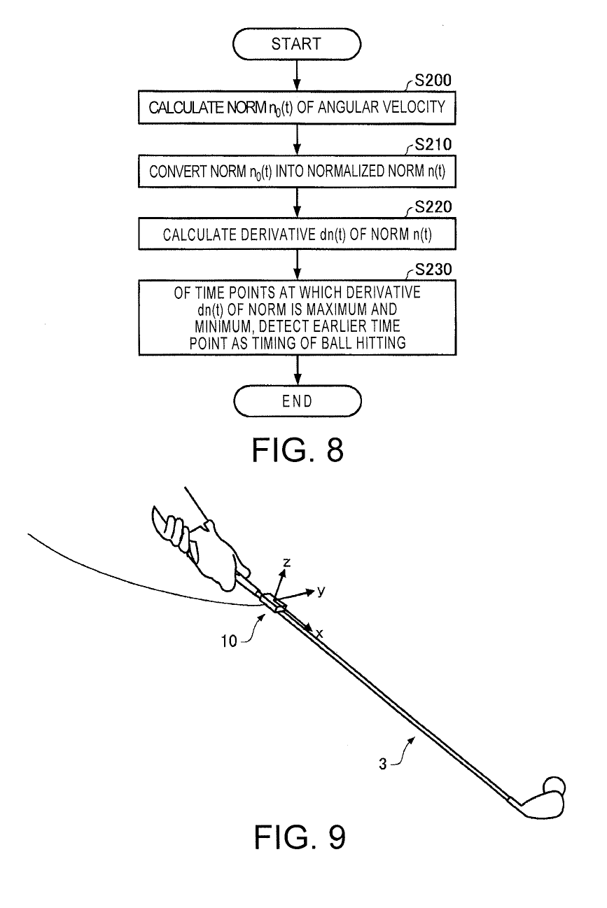

FIG. 8 is a flowchart illustrating examples of procedures of a process (the process in step S30 in FIG. 7) of detecting a timing at which the subject 2 has hit the ball.

As illustrated in FIG. 8, first, the processing section 200 calculates a value of the norm n₀(t) of angular velocity at each time point t using the acquired angular velocity data (angular velocity data for each time point t) (step S200). For example, if the angular velocity data items at the time point t are respectively indicated by x(t), y(t), and z(t), the norm n₀(t) of the angular velocity is calculated according to the following Equation (1).

[Equation 1]

n₀(t)=\sqrt{x(t)²+y(t)²+z(t)²} (1)

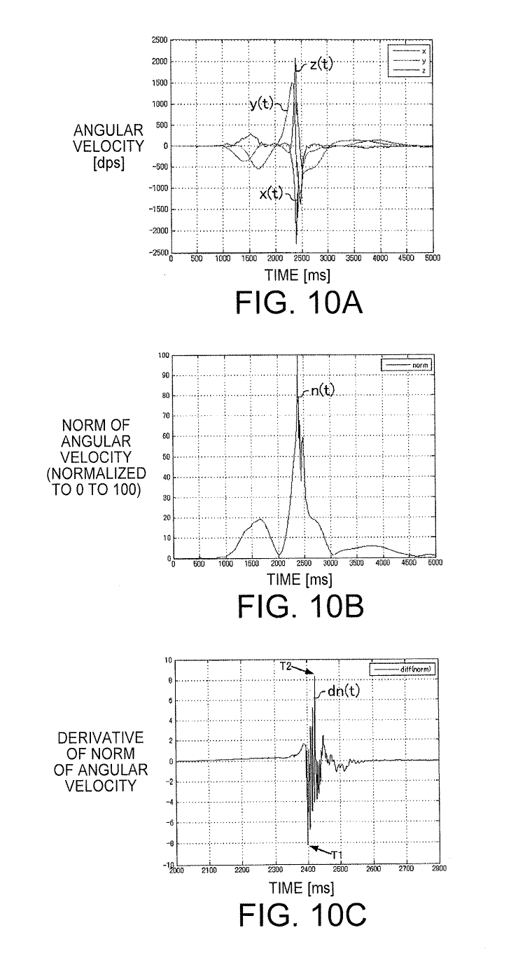

As illustrated in FIG. 9, the sensor unit 10 is attached to the vicinity of the grip of the shaft of the golf club 3 so that the x axis is directed in a direction parallel to the long axis of the shaft, the y axis is directed in a swing direction, and the z axis is directed in a direction which is perpendicular to the swing plane. FIG. 10(A) illustrates examples of three-axis angular velocity data items x(t), y(t) and z(t) obtained when the subject 2 hits the golf ball 4 by performing a swing. In FIG. 10(A), a transverse axis expresses time (msec), and a longitudinal axis expresses angular velocity (dps).

Next, the processing section 200 converts the norm n₀(t) of the angular velocity at each time point t into a norm n(t) which is normalized (scale-conversion) within a predetermined range (step S210). For example, if the maximum value of the norm of the angular velocity in an acquisition period of measured data is max (n₀), the norm n₀(t) of the angular velocity is converted into the norm n(t) which is normalized within a range of 0 to 100 according to the following Equation (2).

$$\begin{matrix}[ Equation 2 ] & \\ n ( t ) = \frac{100 \times {n}_{0} ( t )}{max ( {n}_{0} )} & ( 2 )\end{matrix}$$

FIG. 10(B) is a diagram in which the norm n₀(t) of the three-axis angular velocities is calculated according to Equation (1) using the three-axis angular velocity data items x(t), y(t) and z(t) in FIG. 10(A), and then the norm n(t) normalized to 0 to 100 according to Equation (2) is displayed in a graph. In FIG. 10(B), a transverse axis expresses time (msec), and a longitudinal axis expresses a norm of the angular velocity.

Next, the processing section 200 calculates a derivative dn(t) of the normalized norm n(t) at each time point t (step S220). For example, if a cycle for measuring three-axis angular velocity data items is indicated by Δt, the derivative (difference) dn(t) of the norm of the angular velocity at the time point t is calculated using the following Equation (3).

[Equation 3]

dn(t)=n(t)−n(t−Δt) (3)

FIG. 10(C) is a diagram in which the derivative dn(t) is calculated according to Equation (3) on the basis of the norm n(t) of the three-axis angular velocities, and is displayed in a graph. In FIG. 10(C), a transverse axis expresses time (msec), and a longitudinal axis expresses a derivative value of the norm of the three-axis angular velocities. In FIGS. 10(A) and 10(B), the transverse axis is displayed at 0 seconds to 5 seconds, but, in FIG. 10(C), the transverse axis is displayed at 2 seconds to 2.8 seconds so that changes in the derivative value before and after ball hitting can be understood.

Finally, of time points at which a value of the derivative dn(t) of the norm becomes the maximum and the minimum, the processing section 200 detects the earlier time point as a ball hitting timing (step S230). It is considered that a swing speed is the maximum at the moment of hitting a ball in a typical golf swing. In addition, since it is considered that a value of the norm of the angular velocity also changes according to a swing speed, a timing at which a derivative value of the norm of the angular velocity is the maximum or the minimum (that is, a timing at which the derivative value of the norm of the angular velocity is a positive maximum value or a negative minimum value) in a series of swing actions can be captured as a timing of ball hitting (impact). Since the golf club 3 vibrates due to ball hitting, a timing at which a derivative value of the norm of the angular velocity is the maximum and a timing at which a derivative value of the norm of the angular velocity is the minimum may occur in pairs, and, of the two timings, the earlier timing may be the moment of ball hitting. Therefore, for example, in the graph of FIG. 10(C), of T1 and T2, T1 is detected as a timing of ball hitting.

In a case where the subject 2 performs a swing action, a series of motions is expected in which the subject stops the golf club at the top position, performs a down swing, hits the ball, and performs follow-through. Therefore, according to the flowchart of FIG. 8, the processing section 200 may detect candidates of timings at which the subject 2 has hit the ball, determine whether or not measured data before and after the detected timing matches the rhythms, fix the detected timing as a timing at which the subject 2 has hit the ball if the data matches the rhythms, and detect the next candidate if the data does not match the rhythms.

In the flowchart of FIG. 8, the processing section 200 detects a timing of ball hitting using the three-axis angular velocity data, but can also detect a timing of ball hitting in the same manner using three-axis acceleration data.

### [Attitude Calculation Process of Sensor Unit]

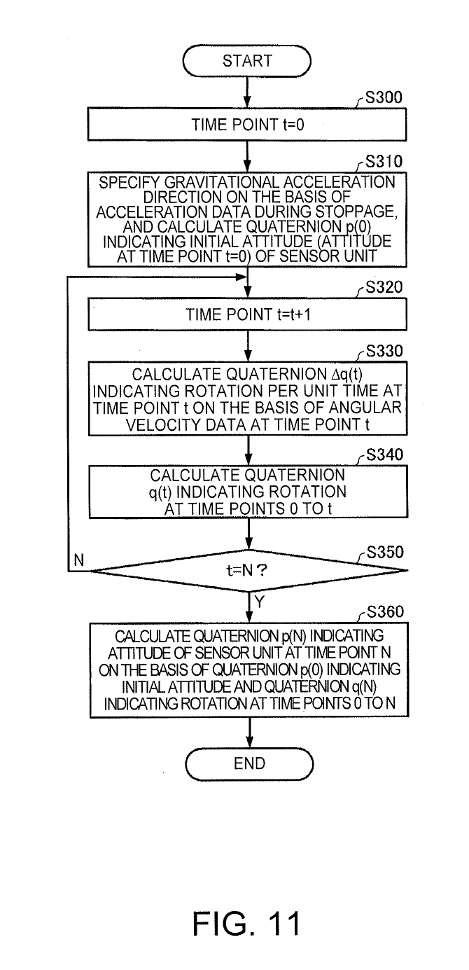

FIG. 11 is a flowchart illustrating examples of procedures of a process (a partial process in step S60 in FIG. 7) of calculating an attitude (an attitude at a time point N) of the sensor unit 10.

As illustrated in FIG. 11, first, at a time point t=0 (step S300), the processing section 200 specifies a direction of the gravitational acceleration on the basis of three-axis acceleration data during stoppage, and calculates a quaternion p(0) indicating an initial attitude (an attitude at the time point t=0) of the sensor unit 10 (step S310).

For example, the quaternion p(0) for the initial attitude is expressed by the following Equation (4).

[Equation 4]

p(0)=(0, X₀, Y₀, Z₀) (4)

A quaternion q indicating rotation is expressed by the following Equation (5).

[Equation 5]

q=(w, x, y, z) (5)

In Equation (5), if a rotation angle of target rotation is indicated by 0, and a unit vector of a rotation axis is indicated by (rₓ, r_{y}, r_{z}), w, x, y, and z are expressed as in Equation (6).

$$\begin{matrix}[ Equation 6 ] & \\ w = cos \frac{θ}{2} , x = {r}_{x} \cdot sin \frac{θ}{2} , y = {r}_{y} \cdot sin \frac{θ}{2} , z = {r}_{z} \cdot sin \frac{θ}{2} & ( 6 )\end{matrix}$$

Since the sensor unit 10 is stopped at the time point t=0 with θ=0, a quaternion q(0) indicating rotation at the time point t=0 is expressed as in the following Equation (7) on the basis of Equation (5) obtained by assigning θ=0 to Equation (6).

[Equation 7]

q(0)=(1,0,0,0). (7)

Next, the processing section 200 updates the time point t to t+1 (step S320), and calculates a quaternion Δq(t) indicating rotation per unit time at the time point t on the basis of three-axis angular velocity data at the time point t (step S320).

For example, if the three-axis angular velocity data at the time point t is indicated by (t)=(ωₓ(t), ω_{y}(t), ω_{z}(t)), the magnitude |ω(t)| of the angular velocity per sample measured at the time point t is calculated using the following Equation (8).

[Equation 8]

|ω(t)|=\sqrt{ωₓ(t)²ω_{y}(t)²+ω_{z}(t)²} (8)

The magnitude |ω(t)| of the angular velocity indicates a rotation angle per unit time, and thus a quaternion Δq(t+1) indicating rotation per unit time at the time point t is calculated using the following Equation (9).

$$\begin{matrix}[ Equation 9 ] & \\ Δ q ( t ) = ( \begin{matrix}cos \frac{\vert ω ( t ) \vert}{2} , \frac{{ω}_{x} ( t )}{\vert ω ( t ) \vert} sin \frac{\vert ω ( t ) \vert}{2} , \\ \frac{{ω}_{y} ( t )}{\vert ω ( t ) \vert} sin \frac{\vert ω ( t ) \vert}{2} , \frac{{ω}_{z} ( t )}{\vert ω ( t ) \vert} sin \frac{\vert ω ( t ) \vert}{2}\end{matrix} ) & ( 9 )\end{matrix}$$

Here, since t=1, the processing section 200 calculates Δq(1) according to Equation (9) using three-axis angular velocity data ω(1)=(ωₓ(1), ω_{y}(1), ω_{z} (1)) at the time point t=1.

Next, the processing section 200 calculates a quaternion q(t) indicating rotation at time points 0 to t (step S340). The quaternion q(t) is calculated according to the following Equation (10).

[Equation 10]

q(t)=q(t−1)·Δq(t) (10)

Here, since t=1, the processing section 200 calculates q(1) according to Equation (10) on the basis of q(0) in Equation (7) and Δq(1) calculated in step S330.

Next, the processing section 200 repeatedly performs the processes in steps S320 to S340 until t becomes N, and, at the time point t=N (Y in step S350), calculates a quaternion p(N) indicating an attitude at the time point N according to the following Equation (11) on the basis of the quaternion p(0) indicating the initial attitude calculated in step S310 and the quaternion q(N) indicating the rotation at the time points t=0 to N in the previous step S340 (step S360), and then finishes the process.

[Equation 11]

p(N)=q(N)·p(0)·q*(N) (11)

In Equation (11), q* (N) is a conjugate quaternion of q(N). p(N) is expressed as in the following Equation (12), and an attitude of the sensor unit 10 at the time point N is (X_{N}, Y_{N}, Z_{N}) when expressed using vectors in the XYZ coordinate system.

[Equation 12]

p(N)=(0, X_{N}, Y_{N}, Z_{N}) (12)

[Display in Which Motion Analysis Information is Correlated with Hit Ball Information]

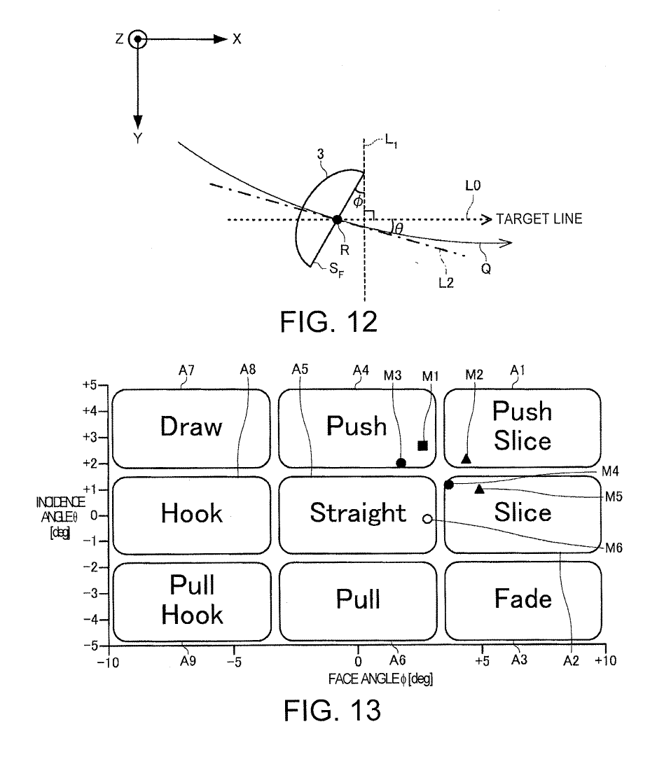

A direction of a hit ball can be predicted on the basis of an incidence angle and a face angle during ball hitting. FIG. 12 is a diagram for explaining an incidence angle and a face angle during ball hitting, and illustrates the golf club 3 (only the head is illustrated) on an XY plane viewed from the positive side of the Z axis in the XYZ coordinate system. In FIG. 12, S_{F} indicates a face surface of the golf club 3, and R indicates a ball hitting point. A dotted arrow L0 indicates a target line, a dashed line L1 indicates a virtual plane orthogonal to the target line L0. A solid line Q is a curve indicating a trajectory of the head of the golf club 3, and a dot chain line L2 indicates a tangential line of the curve Q at the ball hitting point R. In this case, an incidence angle θ is an angle formed between the target line L0 and the tangential line L2, and a face angle φ is an angle formed between the virtual plane L1 and the face surface S_{F}.

As described above, the processing section 200 generates motion analysis information using a trajectory of the motion analysis model, but, since there is an error between the trajectory of the motion analysis model and an actual trajectory of a swing performed by the subject 2, it is difficult to calculate an accurate incidence angle and face angle or to accurately calculate where the face surface comes into contact with a ball during ball hitting. Therefore, it cannot be said that a prediction result of a hit ball direction matches an actual hit ball direction. Thus, in the present embodiment, the subject 2 is made to perform a predetermined action (the action in step S4 in FIG. 1) correlated with a hit ball direction, and the processing section 200 specifies an actual hit ball direction by detecting the action, and displays motion analysis information and hit ball information including the hit ball direction on the display section 260 in correlation with each other.

FIG. 13 is a diagram illustrating an example of a display screen in which the motion analysis information and the hit ball information are correlated with each other. In the example illustrated in FIG. 13, a face angle φ during ball hitting is allocated to a transverse axis, an incidence angle θ during ball hitting is allocated to a longitudinal axis, and nine separate regions A1 to A9 of three rows and three columns are displayed. Characters “Straight” are displayed for trajectory prediction in the central region A5 among the nine regions A1 to A9. In addition, for a right-handed golfer, characters “Push” are displayed for trajectory prediction in the region A4 which is moved in a positive direction of the incidence angle θ from the central region A5, and, similarly, characters “Pull” are displayed for trajectory prediction in the region A6 which is moved in a negative direction of the incidence angle θ from the central region A5. Characters “Push Slice”, “Slice”, and “Fade” are respectively displayed for trajectory prediction in the regions A1, A2, and A3 which are moved in a positive direction of the face angle φ from the regions A4, A5, and A6. In addition, characters “Draw”, “Hook”, and “Pull Hook” are respectively displayed for trajectory prediction in the regions A7, A8, and A9 which are moved in a negative direction of the face angle φ from the regions A4, A5, and A6.

In the example illustrated in FIG. 13, the subject 2 hits the ball six times, and marks M1 to M6 indicating hit ball directions are displayed at coordinate positions corresponding to measured face angles φ and incidence angles θ. The marks M1 to M6 respectively correspond to first ball hitting to sixth ball hitting. The mark is displayed in a “circular shape” if a hit ball direction is the central direction, in a “triangular shape” if a hit ball direction is the right direction, and in a “square shape” if a hit ball direction is the left direction. The mark M6 indicating a hit ball direction in the latest ball hitting is displayed white. The subject 2 views the display image as illustrated in FIG. 13 and can thus recognize a trend of a relationship between the face angle φ and the incidence angle θ, and a hit ball direction, or a relationship between a predicted hit ball direction and an actual hit ball direction.

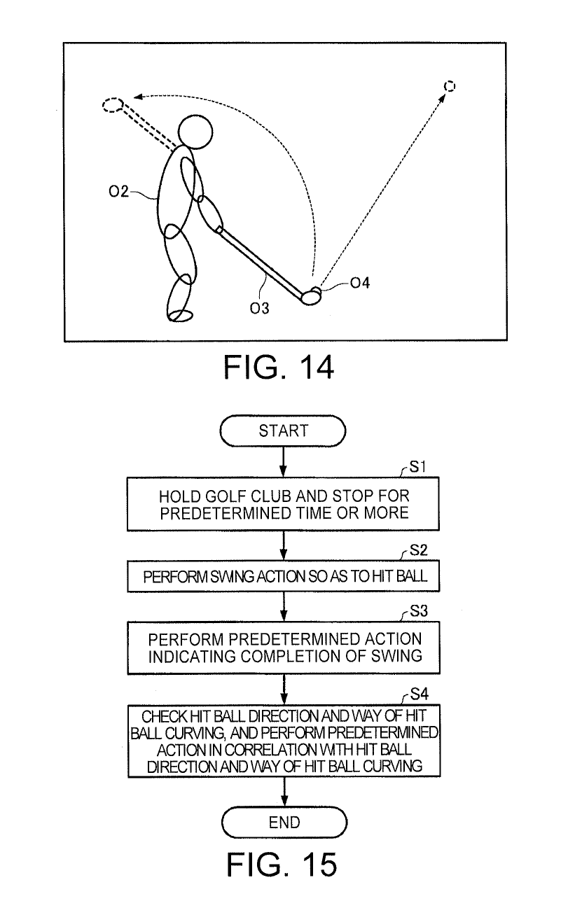

FIG. 14 is a diagram illustrating another example of a display screen in which motion analysis information and hit ball information are correlated with each other. In the example illustrated in FIG. 14, a three-dimensional animation image is displayed which is disposed in a virtual three-dimensional space and in which objects O2, O3 and O4 respectively modeling the subject 2, the golf club 3, and the golf ball 4 are moved (positions or attitudes are changed) over time. Motion of the object O2 or O3 is calculated on the basis of trajectory information of a motion analysis model. In addition, motion of the object O4 is calculated on the basis of a hit ball direction which is specified on the basis of a predetermined action (the action in step S4 in FIG. 3) performed by the subject 2. The subject 2 views the animation image as illustrated in FIG. 14 and can thus recognize a swing form, and a relationship between a trajectory of the golf club and a hit ball direction.

As described above, according to the motion analysis system 1 or the motion analysis apparatus 20 of the first embodiment, it is possible to analyze a swing action of the subject 2 using measured data from the sensor unit 10, and to store and display a swing analysis result and a hit ball direction in association with each other by detecting a simple action performed after the subject 2 hits a ball, such as indicating the hit ball direction or twisting the golf club 3 or the arm so as to specify the hit ball direction. Therefore, the subject can visually recognize a relationship between the motion analysis result and the hit ball direction without imposing an excessive burden thereon.

According to the motion analysis system 1 or the motion analysis apparatus 20 of the first embodiment, it is possible to clearly differentiate a ball hitting action of the subject from a predetermined action for specifying a hit ball direction by detecting a simple action such as tapping the ground with the golf club 3 or stopping for a predetermined time or more, performed after the subject 2 hits the ball and before the subject performs the predetermined action for specifying the hit ball direction. Therefore, it is possible to reduce a probability of wrongly specifying a hit ball direction.

### 1-2. Second Embodiment

In the motion analysis system 1 of a second embodiment, the motion analysis apparatus 20 generates hit ball information including a hit ball direction and the way of a hit ball curving, and stores and displays analysis information and the hit ball information in correlation with each other. A fundamental configuration of the motion analysis system 1 of the second embodiment is the same as in the first embodiment, and thus the same constituent elements as those of the motion analysis system 1 of the first embodiment are given the same reference numerals, and repeated description will be omitted. Hereinafter, a description will be made focusing on the content which is different from the first embodiment.

FIG. 15 is a diagram illustrating procedures of actions performed by the subject 2 in the motion analysis system 1 of the second embodiment. As illustrated in FIG. 15, the subject 2 holds the golf club 3 and stops for a predetermined time period or more (S1), performs a swing action so as to hit the golf ball 4 (S2), and performs a predetermined action indicating completion of the swing (S3), in the same manner as in FIG. 3.

Finally, the subject 2 checks a hit ball direction and the way of the hit ball curving, and performs a predetermined action (an example of a third action) in correlation with the hit ball direction and the way of the hit ball curving (S4).

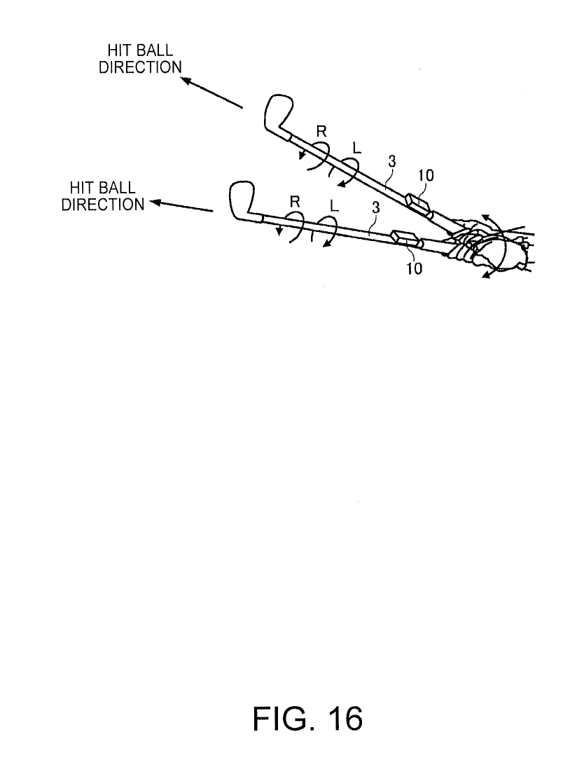

FIG. 16 is a diagram for explaining an example of an action performed by the subject in correlation with the hit ball direction and the way of the hit ball curving in step S4 in FIG. 15. For example, as illustrated in FIG. 16, the subject 2 performs an action of twisting the arm holding the golf club 3 to the right in a case where the golf ball 4 is sliced to curve right, and performs an action of twisting the arm to the left in a case where the ball is hooked to curve left, while indicating the hit ball direction with the golf club 3. If the subject 2 twists the arm, the sensor unit 10 is rotated to the right (R) (rotated clockwise) or to the left (L) (rotated counterclockwise) around a long axis (shaft axis) of the golf club 3. In a case where the action illustrated in FIG. 16 is performed, for example, the subject 2 may not perform an action of twisting the arm in a case where the golf ball 4 flies without curving, and may perform an action of twisting the golf club 3 or the arm so that a rotation amount or a rotation speed of the sensor unit 10 is increased as curving becomes larger in a case where the golf ball 4 flies while curving.

The motion analysis apparatus 20 analyzes motion performed by the subject 2 using data measured by the sensor unit 10, so as to generate motion analysis information (swing information) and hit ball information (including the hit ball direction and the way of the hit ball curving), and stores the information pieces in the storage section in correlation with each other. The motion analysis apparatus 20 displays the motion analysis information and the hit ball information on a display section in correlation with each other through a predetermined input operation or automatically.

Particularly, in the present embodiment, the action detection portion 202 detects the stoppage action (the action in step S1 in FIG. 15) performed by the subject 2 before starting a swing action, the predetermined action (the action in step S3 in FIG. 15) indicating completion of the swing, and the predetermined action (the action in step S4 in FIG. 15) performed in correlation with the hit ball direction and the way of the ball curving, in correlation with the time. The action detection portion 202 detects a timing (time point) at which the subject 2 has hit the ball in the period of the swing action (the action in step S2 in FIG. 15).

The hit ball information generation portion 204 specifies a hit ball direction and the way of the hit ball curving according to the predetermined action (the action in step S4 in FIG. 15) performed by the subject 2 in correlation with the hit ball direction and the way of the hit ball curving, detected by the action detection portion 202, and generates hit ball information including the hit ball direction and the way of the hit ball curving. In a case where the subject 2 does not want to store information regarding a hit ball direction and the way of the hit ball curving such as a case where the subject has missed a ball, or causes the ball not to fly almost straight, the subject may not perform the predetermined action correlated with a hit ball direction and the way of the hit ball curving.

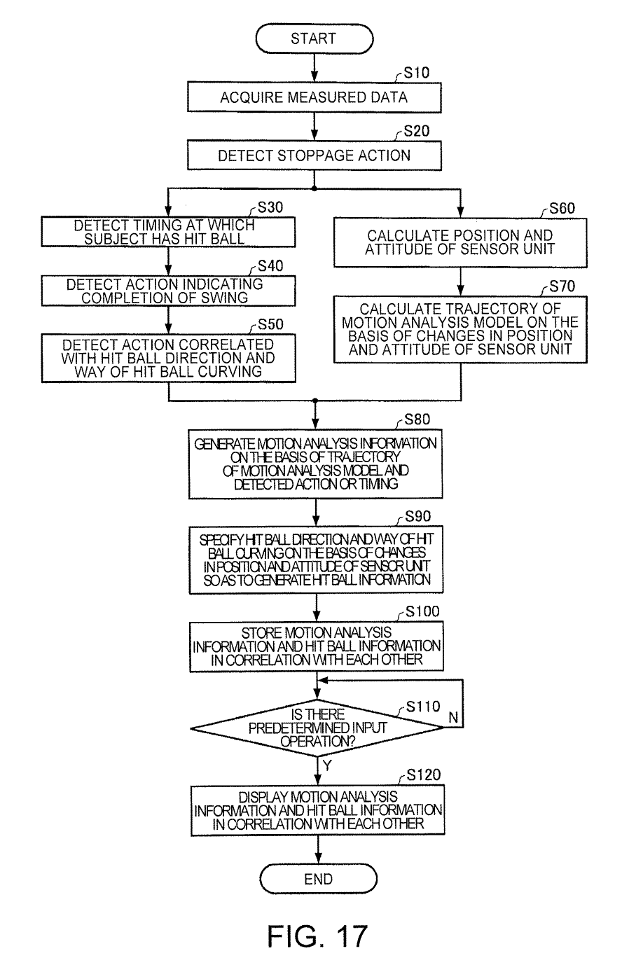

FIG. 17 is a flowchart illustrating examples of procedures of a motion analysis process performed by the processing section 200 in the second embodiment.

As illustrated in FIG. 17, in the same manner as in FIG. 7, first, the processing section 200 performs processes in steps S10 and S20, and processes in steps S30 to S50 and processes in steps S60 and S70 in parallel. Particularly, in the present embodiment, the processing section 200 performs a process of detecting an action correlated with a hit ball direction and the way of the hit ball curving in step S50.

Next, the processing section 200 performs a process in step S80 in the same manner as in FIG. 7, and then performs a process of specifying the hit ball direction and the way of the golf ball 4 curving on the basis of changes in the position or the attitude of the sensor unit 10 so as to generate hit ball information (S90).

Next, the processing section 200 stores the motion analysis information and the hit ball information generated in step S80 in correlation with each other (S100).

Finally, the processing section 200 displays the motion analysis information and the hit ball information stored in step S100, in correlation with each other, in a case where there is a predetermined input operation (Y in S110) (S120).

In step S120, the processing section 200 may display a face angle φ and an incidence angle θ during ball hitting, and a hit ball direction and the way of the hit ball curving in correlation with each other on a screen as illustrated in FIG. 13. In this case, for example, nine marks including combinations of three hit ball directions (the central direction, the right direction, and the left direction) and three curving ways (no curving, right curving, and left curving) may be displayed at coordinate positions corresponding to measured face angles φ and incidence angles θ. For example, whether three marks for specifying a hit ball direction are displayed at the coordinate positions corresponding to the measured face angles φ and incidence angles θ, or three marks for specifying the way of the golf ball 4 curving are displayed at the coordinate positions may be selected through an input operation. For example, if three marks for specifying one of a hit ball direction and the way of the hit ball curving are displayed at coordinate positions corresponding to measured face angles φ and incidence angles θ, and one of the displayed marks is selected, the display may be changed to three marks for specifying the other of the hit ball direction and the way of the hit ball curving. The subject 2 views such a display image, and can thus recognize a trend of a relationship between the face angle φ and the incidence angle θ, and a hit ball direction and the way of the hit ball curving, or a relationship between a predicted hit ball direction or way of the hit ball curving, and an actual hit ball direction or way of the hit ball curving.

Alternatively, in step S120, the processing section 200 may display, for example, an animation image as illustrated in FIG. 14, and cause the object O2 modeling the golf ball 4 to curve right or left so that the ball flies to the right direction or the left direction. The subject 2 views such an animation image, and can thus recognize a swing form, and a relationship between a trajectory of the golf club and a hit ball direction or the way of the hit ball curving.

According to the motion analysis system 1 or the motion analysis apparatus 20 of the second embodiment, it is possible to analyze a swing action of the subject 2 using measured data from the sensor unit 10, and to store and display a swing analysis result, and a hit ball direction and the way of the hit ball curving in association with each other by detecting a simple action performed after the subject 2 hits the ball, such as twisting the golf club 3 or the arm while indicating the hit ball direction so as to specify the hit ball direction and the way of the hit ball curving. Therefore, the subject can visually recognize a relationship between the motion analysis result and the hit ball direction and the way of the hit ball curving without imposing an excessive burden thereon.

According to the motion analysis system 1 or the motion analysis apparatus 20 of the second embodiment, it is possible to clearly differentiate a ball hitting action of the subject 2 from a predetermined action for specifying a hit ball direction and the way of the hit ball curving by detecting a simple action performed after the subject 2 hits the ball and before the subject performs the predetermined action for specifying the hit ball direction and the way of the hit ball curving. Therefore, it is possible to reduce a probability of wrongly specifying a hit ball direction or the way of the hit ball curving.

### 2. MODIFICATION EXAMPLES

The invention is not limited to the present embodiment, and may be variously modified within the scope of the spirit of the invention.

For example, the subject 2 may perform an action of tapping the ground with the golf club 3 by the number of times corresponding to a hit ball direction in order to specify the hit ball direction or the way of the hit ball curving. For example, an action of tapping once indicates that a hit ball direction is a central direction, or the ball does not curve, an action of tapping twice indicates that a hit ball direction is the right direction, or the ball curves right, and an action of tapping three times indicates that a hit ball direction is the left direction, or the ball curves left.

In the above-described respective embodiments, the motion analysis apparatus 20 specifies a hit ball direction using measured data from the acceleration sensor 100 or the angular velocity sensor 110 mounted in the sensor unit 10, but, other kinds of sensors may be mounted in the sensor unit 10, and the motion analysis apparatus 20 may specify a hit ball direction using measured data from the sensors. For example, since a geomagnetic sensor measures an azimuth, the motion analysis apparatus 20 can easily specify whether a hit ball direction is the central direction, the right direction, or the left direction, using measured data from the geomagnetic sensor.

In the above-described respective embodiments, the motion analysis apparatus 20 specifies left and right hit ball directions, that is, hit ball directions projected on the horizontal plane using measured acceleration data or angular velocity data, but may specify upper and lower hit ball directions, that is, hit ball directions projected onto a plane which is perpendicular to the horizontal plane. The sensor unit 10 may be provided with a different kind of sensor from the acceleration sensor or the angular velocity sensor, and the motion analysis apparatus 20 may specify upper and lower hit ball directions using measured data from the sensor. For example, since a pressure sensor measures the atmospheric pressure (the atmospheric pressure becomes lower as the altitude becomes higher), the motion analysis apparatus 20 can easily specify whether a hit ball direction is an upper direction or a lower direction using measured data from the pressure sensor.

In the above-described respective embodiments, the motion analysis system (motion analysis apparatus) analyzing a golf swing has been exemplified, but the invention is applicable to a motion analysis system (motion analysis apparatus) using various exercise appliances such as a tennis racket or a baseball bat.

In the above-described respective embodiments, the motion analysis apparatus 20 performs motion analysis using measured data from a single sensor unit 10, but, a plurality of sensor units 10 may be attached to the golf club 3 or the subject 2, and the motion analysis apparatus 20 may perform motion analysis using measured data from the plurality of sensor units 10.

In the above-described respective embodiments, the sensor unit 10 and the motion analysis apparatus 20 are provided separately from each other, but maybe integrated into a motion analysis apparatus which can be attached to an exercise appliance or a subject.

The above-described respective embodiments and respective modification examples are only examples, and the invention is not limited thereto. For example, the respective embodiments and the respective modification examples may be combined with each other as appropriate.

For example, the invention includes substantially the same configuration (for example, a configuration in which functions, methods, and results are the same, or a configuration in which objects and effects are the same) as the configuration described in the embodiment. The invention includes a configuration in which an in essential part of the configuration described in the embodiment is replaced with another part. The invention includes a configuration which achieves the same operation and effect or a configuration capable of achieving the same object as in the configuration described in the embodiment. The invention includes a configuration in which a well-known technique is added to the configuration described in the embodiment.

### REFERENCE SIGNS LIST

1 MOTION ANALYSIS SYSTEM

2 SUBJECT

3 GOLF CLUB

4 GOLF BALL

10 SENSOR UNIT

20 MOTION ANALYSIS APPARATUS

100 ACCELERATION SENSOR

110 ANGULAR VELOCITY SENSOR

120 SIGNAL PROCESSING SECTION

130 COMMUNICATION SECTION

200 PROCESSING SECTION

201 DATA ACQUISITION PORTION

202 ACTION DETECTION PORTION

203 MOTION ANALYSIS PORTION

204 HIT BALL INFORMATION GENERATION PORTION

205 STORAGE PROCESSING PORTION

206 DISPLAY PROCESSING PORTION

210 COMMUNICATION SECTION

220 OPERATION SECTION

230 ROM

240 RAM

250 RECORDING MEDIUM

260 DISPLAY SECTION

1. A motion analysis apparatus comprising:
an action detection portion that detects a first action performed in correlation with a hit ball direction after a subject hits a ball using measured data which is measured by a sensor unit attached to at least one of an exercise appliance and the subject operating the exercise appliance;
a hit ball information generation portion that specifies a hit ball direction according to the first action and generates hit ball information including the hit ball direction;
a motion analysis portion that analyzes motion in which the subject has hit the ball using the exercise appliance and generates motion analysis information; and
a storage processing portion that stores the motion analysis information and the hit ball information in a storage section in correlation with each other.

2. The motion analysis apparatus according to claim 1, further comprising:
a display processing portion that displays the motion analysis information and the hit ball information on a display section in correlation with each other.

3. The motion analysis apparatus according to claim 1,
wherein the first action is an action of indicating a hit ball direction.

4. The motion analysis apparatus according to claim 1,
wherein the first action is an action of twisting the exercise appliance or the arm of the subject.

5. The motion analysis apparatus according to claim 1,
wherein the action detection portion detects a second action performed after the subject hits the ball using the exercise appliance and before the subject performs the first action, using the measured data, and
wherein, in a case where the second action is detected, the hit ball information generation portion specifies a hit ball direction according to the first action and generates hit ball information including the hit ball direction.

6. The motion analysis apparatus according to claim 5,
wherein the second action is an action of applying impact to the exercise appliance.

7. The motion analysis apparatus according to claim 5,
wherein the second action is an action of stopping the exercise appliance.

8. The motion analysis apparatus according to claim 1,
wherein the action detection portion detects a third action performed in correlation with the way of a hit ball curving after the subject hits the ball, using the measured data, and
wherein the hit ball information generation portion specifies the way of the hit ball curving according to the third action and generates the hit ball information including the hit ball direction and the way of the hit ball curving.

9. The motion analysis apparatus according to claim 1,
wherein the motion analysis portion generates the motion analysis information using the measured data.

10. A motion analysis system comprising:
the motion analysis apparatus according to claim 1, and
the sensor unit.

11. A motion analysis method comprising:
detecting a first action performed in correlation with a hit ball direction after a subject hits a ball using measured data which is measured by a sensor unit attached to at least one of an exercise appliance and the subject operating the exercise appliance;
generating hit ball information including hit ball direction by specifying the hit ball direction according to the first action;
generating motion analysis information by analyzing motion in which the subject has hit the ball using the exercise appliance; and
storing the motion analysis information and the hit ball information in a storage section in correlation with each other.

12. The motion analysis method according to claim 11, further comprising:
calculating an attitude of the sensor unit using measured data which is measured by the sensor unit,
wherein, in the generating of the hit ball information, the hit ball direction is specified on the basis of an attitude of the sensor unit when the subject performs the first action.

13. The motion analysis method according to claim 12, further comprising:
detecting a timing at which the subject has hit the ball using data measured by the sensor unit after the subject starts motion;
detecting a second action performed before the subject performs the first action, using data measured by the sensor unit after the timing; and
generating hit ball information including a hit ball direction by specifying the hit ball direction according to the first action after detecting the second action.

14. A display method of motion analysis information comprising:
detecting a first action performed in correlation with a hit ball direction after a subject hits a ball using measured data which is measured by a sensor unit attached to at least one of an exercise appliance and the subject operating the exercise appliance;
generating hit ball information including a hit ball direction by specifying the hit ball direction according to the first action;
analyzing motion in which the subject has hit the ball using the exercise appliance, so as to generate motion analysis information; and
displaying the motion analysis information and the hit ball information on a display section in correlation with each other.

15. A program causing a computer to execute:
detecting a first action performed in correlation with a hit ball direction after a subject hits a ball using measured data which is measured by a sensor unit attached to at least one of an exercise appliance and the subject operating the exercise appliance;
generating hit ball information including a hit ball direction by specifying the hit ball direction according to the first action;
generating motion analysis information by analyzing motion in which the subject has hit the ball using the exercise appliance; and
displaying the motion analysis information and the hit ball information on a display section in correlation with each other.
